(19) United States
(12) Patent Application Publication
(10) Pub. No.: US 2011/0248231 A1
(43) Pub. Date: Oct. 13, 2011

(54) FENCING ASSEMBLY

(76) Inventors: Wayne Milner, Victoria (AU); Rudy Diener, New South Wales (AU)

(21) Appl. No.: 13/083,720

(22) Filed: Apr. 11, 2011

(30) Foreign Application Priority Data
Apr. 13, 2010 (AU) 2010901562

(51) Int. Cl. E04H 17/16; B23P 11/00; E04H 17/14

(52) U.S. Cl. 256/24; 256/59; 256/65.03; 29/428

(57) ABSTRACT

A fencing assembly (10) comprising a plurality of elongate paling members (23) having a top and a bottom and longitudinal sides; at least one top rail (14) which includes at least one opening (22) configured to receive a top portion of at least one paling member (23); at least one bottom rail (18) which includes at least one opening (22) configured to receive a bottom portion of at least one paling member (23); at least two side members (20) extending between the top rail (14) and bottom rail (18); and at least one intermediate rail (16) spaced between top rail (14) and bottom rail (18), the intermediate rail (16) comprising two elongate members (24, 25), each elongate member (24, 25) extending over a portion of opposite longitudinal sides of paling members (23) proximate the intermediate rail (16) and compress these portions of the paling members (23) between each elongate member (24, 25).

### FIELD OF THE INVENTION

The present invention generally relates to a fencing assembly. The invention is particularly applicable for the construction of dividing or border fences for residential and commercial properties and it will be convenient to hereinafter disclose the invention in relation to that exemplary application. However, it is to be appreciated that the invention is not limited to that application.

### BACKGROUND OF THE INVENTION

The following discussion of the background to the invention is intended to facilitate an understanding of the invention. However, it should be appreciated that the discussion is not an acknowledgement or admission that any of the material referred to was published, known or part of the common general knowledge as at the priority date of the application.

Fences are widely used in an urban environment around the perimeter of a property, or as dividers between sections of a property. In Australia, timber paling fences are widely used in residential areas. Common configurations of timber paling fences are those with an overlapping paling structure or a closed paling (end on end) structure.

Fence construction is generally a laborious and time consuming process. For a wooden paling fence, a skilled fencer will cut palings to size, construct a plurality of spaced apart vertical support posts, fasten cross-rails to each of these support posts using fasteners such as nails or screws, and then fasten each paling to these cross-rails. Fence construction of this nature can take several days when erecting a fence around a standard residential property.

However, such traditionally built wooden fencing arrangements can weather badly overtime when exposed to outdoor environmental conditions. In some instances, the paling of these fences can shrink or warp leading to undesirable paling aesthetics. In other instances, the fasteners holding the palings and/or cross-rails can rust and break releasing the palings from the cross-rails or cross-railings from the support posts. In some cases, the wood of the palings can shrink around the fasteners, causing loose palings.

It would therefore be desirable to provide a paling fencing arrangement that reduces the construction time of a fence and preferably overcomes some of the identified weathering problems.

### SUMMARY OF THE INVENTION

According to the present invention, there is provided a fencing assembly suitable for use for forming one or more fence panels. The fencing assembly includes a plurality of elongate paling members having a top and a bottom. One or more top rail is also provided which includes at least one opening configured to receive a top portion of at least one paling member. The fencing assembly also includes at least one bottom rail which includes at least one opening configured to receive a bottom portion of at least one paling member. Two or more side members are also provided. The side members extend between the top rail and bottom rail, and in some forms take the form of fence posts from which the top rail and bottom rail are affixed. The fencing assembly also includes one or more intermediate rail spaced between top rail and bottom rail. The intermediate rail comprises two elongate members or halves. Each elongate member extends over a portion of opposite longitudinal sides of paling members proximate. These halves of the intermediate rail compress these portions of the paling members between each elongate member.

This fencing assembly simplifies the construction of a fence. The openings in the top rail and bottom rail allow the paling members to be slotted into place without using nails or screws. The fence can then be more quickly and reliably constructed. The intermediate rail adds strength and aesthetic appeal to the constructed fence. In this respect, the intermediate rail ties the palings together, adding rigidity to the constructed fencing structure. Furthermore, the two halves of the intermediate rail compress the intermediate portion of the paling members together to hold the paling members together in close proximity. The reduction of nail and screw fasteners in the assembly reduce the weathering propensity of the structure. In this respect, the palings (if constructed of wood) can move, shrink or similar and will still be held in place within the openings of the top rail and bottom rail with minimal change to the broad appearance of the fencing structure.

The configuration of the openings of the top and bottom rail depends on the fencing configuration desired to be erected.

In some instances, a lapped fencing structure may be desired. In this type of fence, the ends of the paling members overlap to provide a lapped or stagged array of paling members. This paling overlap ensures that any lateral movement or warping of the palings does not introduce a gap between palings.

For a lapped paling fencing structure, the top rail and bottom rail include a plurality of openings adapted to receive overlapping paling members. The openings of these rails are generally arranged in two substantially parallel rows along the longitudinal length of the respective rail, with adjoining openings from each row being staggered to provide a lapped array of openings. Each row of openings is preferably spaced apart from each adjoining opening in the same row and longitudinally overlaps a portion of each adjacent opening in the other row. Therefore, the paling members are configured into a staggered pattern when the top portions and the bottom portions of each paling are inserted into the openings in the top rail and bottom rail respectively.

Each opening in the top rail and the bottom rail may be configured to receive a plurality of top or bottom portions of paling members. However, for a lapped configuration it is preferred that each opening is configured to receive a single top portion or bottom portion of a paling member. Each opening is also preferably configured to closely fit the cross-sectional shape of the paling member. In this most cases, each opening would have a general rectangular shape.

In some instances, a closed paling fence is desired. A closed paling fence has paling members fixed to cross-bearers in an end-to-end configuration. To achieve this paling structure, the top rail and bottom rail preferably include at least one elongate opening adapted to receive two or more paling members arranged with adjacent longitudinal ends of adjoining paling members in substantially abutting contact. Though, it should be understood that the longitudinal ends of paling members may be spaced apart by a small distance if gaps are desired in the fencing structure.

Unlike the openings of the lapped configuration, the opening or openings are arranged in a single row along the longitudinal length of the top and bottom rail. Furthermore, while a plurality of openings can be provided in each rail, it is preferred that the opening in the top rail and bottom rail comprises a single elongate channel having a width which substantially accommodates the width of the paling member receivable within the opening. This allows the longitudinal end of each paling member to abut the end of an adjacent member when the top portion or bottom portion is inserted into that opening.

The intermediate rail adds rigidity and structure to the fencing structure being constructed from a fencing assembly according to the present invention. The intermediate rail of the present invention is formed in two halves. During construction of a fencing structure, the first half of the intermediate rail is attached to a first side of the assembly over the first longitudinal side of the paling members and a second half of the intermediate rail is attached to the second side of the assembly over the second longitudinal side paling members. One or more fastener, such as a nut and bolt or similar is then fixed through the first half and second half along the length of the intermediate rail to compress the palings between each half of the intermediate rail.

For a lapped fencing configuration, the intermediate rail compresses the overlapping portions of the paling members together. This reduces gaps between the paling members introduced from the small lateral spacing of the opening between the parallel rows of openings in the top and bottom rail.

For a closed fencing configuration, the intermediate rail holds the proximate portion of the paling members together reducing lateral and perpendicular (relative to the longitudinal length of the paling members) movement of the paling members between the top and bottom rail.

Any number of fasteners can be fixed between the two halves of the intermediate railing. However, it is preferred at least three or more fasteners, and preferably four or more fasteners are fixed through the first half and second half along the length of the intermediate rail to add sufficient strength and compression. Any suitable fastener can be used. In one embodiment, the fasteners comprise a bolt and nut which extends through openings formed within each half of the intermediate rail and the respective palings.

The top rail, bottom rail and intermediate rail can be formed of any suitable material. In one exemplary embodiment, each of the top rail, bottom rail and intermediate rail comprise an elongate metal tube having a rectangular hollow section.

The top rail, bottom rail and intermediate rail can be affixed to the side members using any suitable means. In one form, each of the ends of the top rail, bottom rail and intermediate rail include a flange or shape projection which can be fastened to the side members. In another form, each side member includes a channel section adapted to receive the end sections of the top rail, bottom rail and intermediate rail of the fence assembly.

In some embodiments, the side members comprise side or support posts which are fixable into the ground.

The fencing assembly of the present invention can be used to form one or more fence panels which can be erected consecutively to form a desired fencing structure.

According to a second aspect of the present invention, there is provided a method of assembling a fence including the steps of:
providing a fencing assembly according to the first aspect of the present invention.
positioning a plurality of fence posts into the ground in a spaced apart arrangement, the fence post including the side members; attaching a plurality of top rail and bottom rails between adjoining fence posts;
supporting a plurality of paling members between each of the top rail and bottom rails, a top portion of each paling member being located in an opening of the top rail and a bottom portion of each paling member being located in an opening of the bottom rail; and
attaching at least one intermediate rail spaced between top rail and bottom rail, the intermediate rail comprising two elongate members, each elongate member extending over a portion of opposite longitudinal sides of paling members proximate the intermediate rail and compress these portions of the paling members between each elongate member.

Again, the intermediate rail is provided in at least two halves. A first half of the intermediate rail is attached to a first side of the assembly and a second half of the intermediate rail is attached to the second side of the assembly, and at least one fastener is fixed through the first half and second half along the length of the intermediate rail to compress the palings between each half of the intermediate rail. A fastener is preferably fixed through the first half and second half at three or more, preferably four or more points along the length of the intermediate rail. This fastens the two halves of the intermediate rail together. Tightening the fasteners compresses the paling members together between the two halves of the intermediate rail

### BRIEF DESCRIPTION OF THE DRAWINGS

The present invention will now be described with reference to the figures of the accompanying drawings, which illustrate particular preferred embodiments of the present invention, wherein:

FIG. 1 is a perspective view of a lapped fencing panel assembly according to one embodiment of the present invention.

FIG. 2 is a perspective view of a metal rail and post framework of the lapped fencing panel assembly shown in FIG. 1.

FIG. 3 is a plan view of a portion of a bottom rail of the lapped fencing panel assembly shown in FIG. 1.

FIG. 4 is a perspective view of a top rail of the of the lapped fencing panel assembly shown in FIG. 1.

FIG. 4A is a side view of a top rail of the of the lapped fencing panel assembly shown in FIG. 1.

FIG. 5 is a perspective view of a bottom rail of the of the lapped fencing panel assembly shown in FIG. 1.

FIG. 5A is a side view of a bottom rail of the of the lapped fencing panel assembly shown in FIG. 1.

FIG. 6 is a perspective view of one half of an intermediate rail of the of the lapped fencing panel assembly shown in FIG. 1.

FIG. 6A is a side view of one half of an intermediate rail of the of the lapped fencing panel assembly shown in FIG. 1.

FIG. 7 is a perspective view of a closed fencing panel assembly according to one embodiment of the present invention.

FIG. 8 is a perspective view of a metal rail and post framework of the closed fencing panel assembly shown in FIG. 7.

FIG. 9 is a plan view of a portion of a bottom rail of the closed fencing panel assembly shown in FIG. 7.

FIG. 10 is a perspective view of a top rail of the of the closed fencing panel assembly shown in FIG. 7.

FIG. 10A is a side view of a top rail of the of the closed fencing panel assembly shown in FIG. 7.

FIG. 11 is a perspective view of a bottom rail of the of the closed fencing panel assembly shown in FIG. 7.

FIG. 11A is a side view of a bottom rail of the of the closed fencing panel assembly shown in FIG. 7.

FIG. 12 is a perspective view of one half of an intermediate rail of the of the closed fencing panel assembly shown in FIG. 7.

FIG. 12A is a side view of one half of an intermediate rail of the of the closed fencing panel assembly shown in FIG. 7.

### DETAILED DESCRIPTION

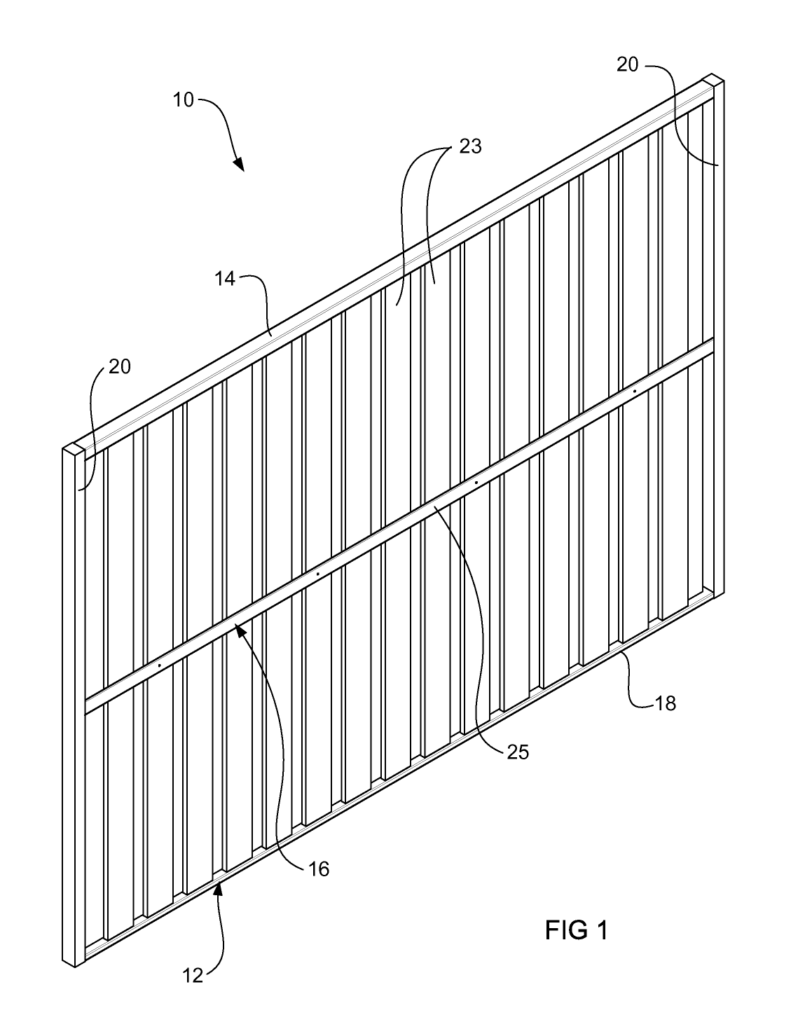

FIGS. 1 to 12 illustrate two different embodiments of a fence panel 10, 110 constructed from fencing assemblies according to the present invention.

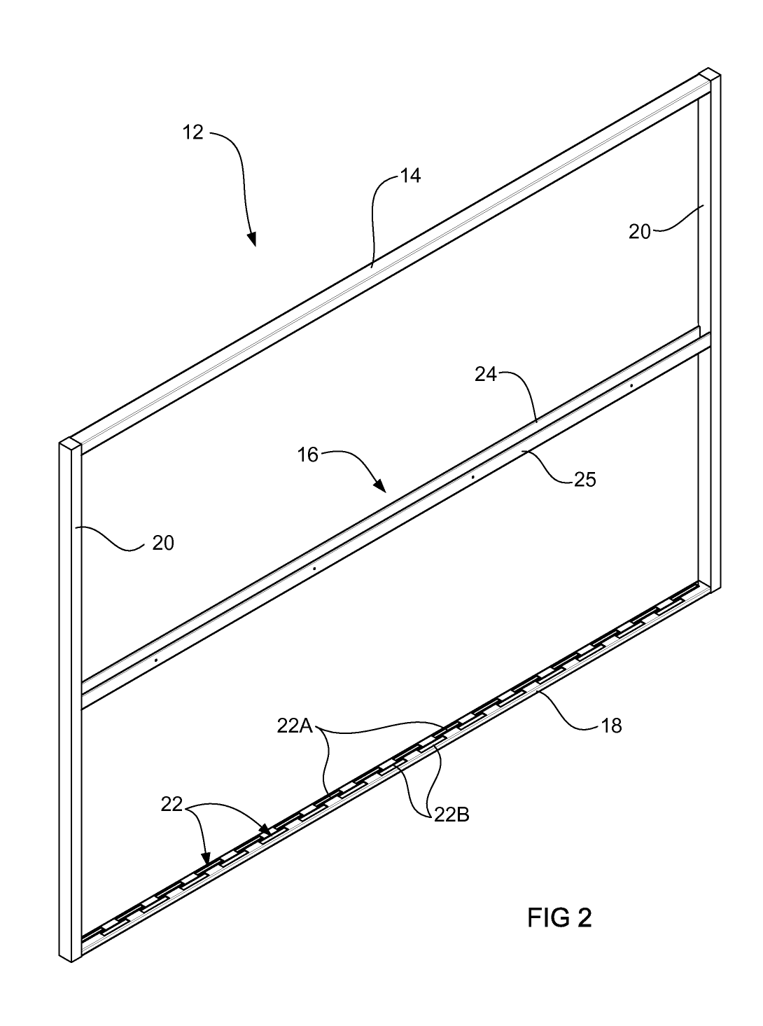

FIGS. 1 to 6 illustrate a lapped paling fencing panel 10. Referring firstly to FIGS. 1 and 2, the panel 10 comprises a metal framework 12 which holds a plurality of paling members 23. The metal framework 12 has an elongate top rail 14, an elongate intermediate rail 16 and an elongate bottom rail 18. Each of the top rail 14, intermediate rail 16 and bottom rail 18 are connected at their ends between two metallic side posts 20. Whilst not shown in the figures, each of the ends of the top rail 14, intermediate rail 16 and bottom rail 18 include flanges which are bolted to the respective portions of the side posts 20. Each of the top rail 14, intermediate rail 16 and bottom rail 18 are spaced apart substantially parallel to one another along the height of each side post 20. The intermediate rail 16 is located midway between the top rail 14 and bottom rail 18.

As shown in FIG. 2, each of the top rail 14 and bottom rail 18 include a plurality of rectangular openings 22 configured to receive an end portion of a fence paling members 23. A plurality of elongate paling members 23 are inserted into these openings 22 to form the lapped structure shown in FIG. 1. Each paling member 23 is rectangular in shape when viewed in plane and is elongate and solid.

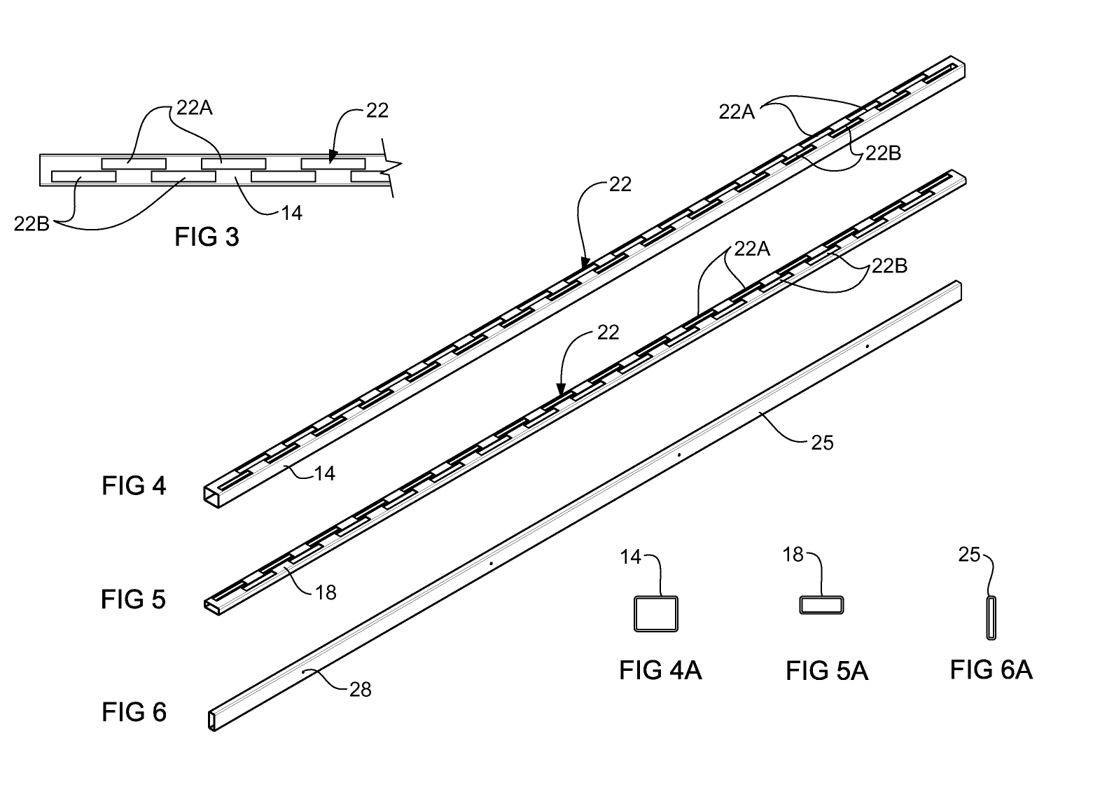

As best seen in FIGS. 3 to 6, each of the top rail 14, intermediate rail 16 and bottom rail 18 is formed from an elongate rectangular metal hollow section tubes. As shown, each section of the respective rails 14, 16, 18 have a rectangular cross-section, though it should be appreciated that other shapes such as a “C” shape, “V” shape or similar could also be used. Each of the top rail 14 and bottom rail 18 has rectangular openings 22 located along the length of the respective rail member 14, 18. The openings 22 are arranged in two parallel rows and are equally spaced along the length of the each rail member 16, 18. Adjoining openings 22A and 22B in each row are staggered to provide a lapped array of openings 22. This spaces apart openings 22 in the same row, and longitudinally overlaps and a portion each adjacent opening 22A with another opening 22B in the other row. Therefore, when the top portions and bottom portions of each paling member 23 are inserted into the openings, the paling members 23 are configured into a staggered/lapped pattern (see FIG. 1).

As best shown in FIG. 2, the intermediate rail 16 is formed from two elongate metal members 24, 25. Each elongate member 24, 25 extend over a portion of the outwardly facing faces of the paling members 23 and compress proximate paling member 23 portions between each elongate member 24, 25. FIG. 6 shows one half 25 of the intermediate rail 16, showing that it is formed from a rectangular metal hollow section tube and has four spaced apart fastening holes 28 set along its length. Fasteners (not shown), such as bolts, can be fixed through each elongate member 24, 25 along the length of the fencing assembly 10. The bolts pass through each fastening hole 28 in the front half of the rail 25 and through a corresponding hole (not shown) in the rear half of the rail 24 and can be fastened by a nut (not shown). Tightening the bolt moves the two halves of the intermediate rail 16 together, compressing the paling members together between these halves 24, 25.

The intermediate rail 16 compresses the middle section of paling members 23 together to bring the lapped paling members 23 together in close contact. This compression closes any gaps between adjacent palings 23 introduced from the small lateral spacing of the opening between the parallel rows of openings 22A and 22B in the top rail 14 and bottom rail 18. Only minimal gaps between paling members 23 can be seen once the halves of the intermediate rail 16 is clamped around the paling members 16. The intermediate rail 16 is also useful in preventing warping of the palings, particularly soft wood palings, due to weathering, ageing, and variations in humidity or the like.

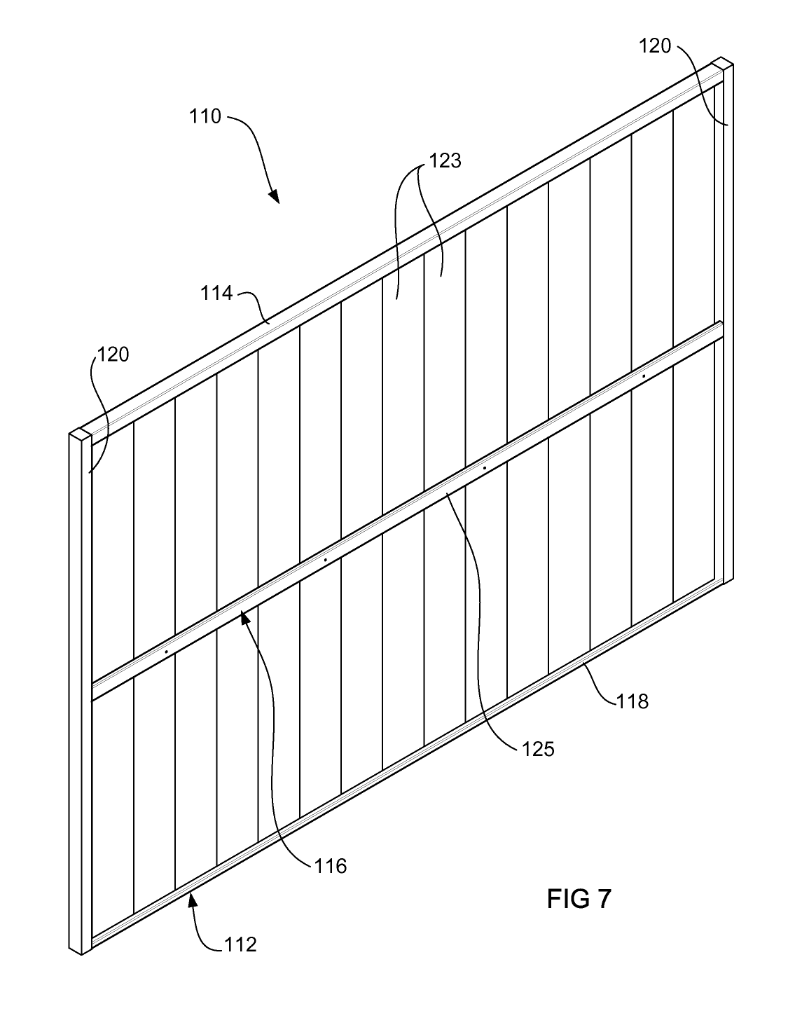

FIGS. 7 to 12 illustrate a closed paling fencing panel 110. Generally each of the illustrated fencing panels 10, 110 includes a number of similar features. Accordingly, like features in the panel 110 shown in FIGS. 7 to 12 have been designated the same reference numeral as the features shown in the panel 10 illustrated in FIGS. 1 to 6 plus 100. The difference between the fence panels 10 and 110 resides in the configuration of openings 22 and 122 for receiving top portions and bottom portions of paling members 23, 123.

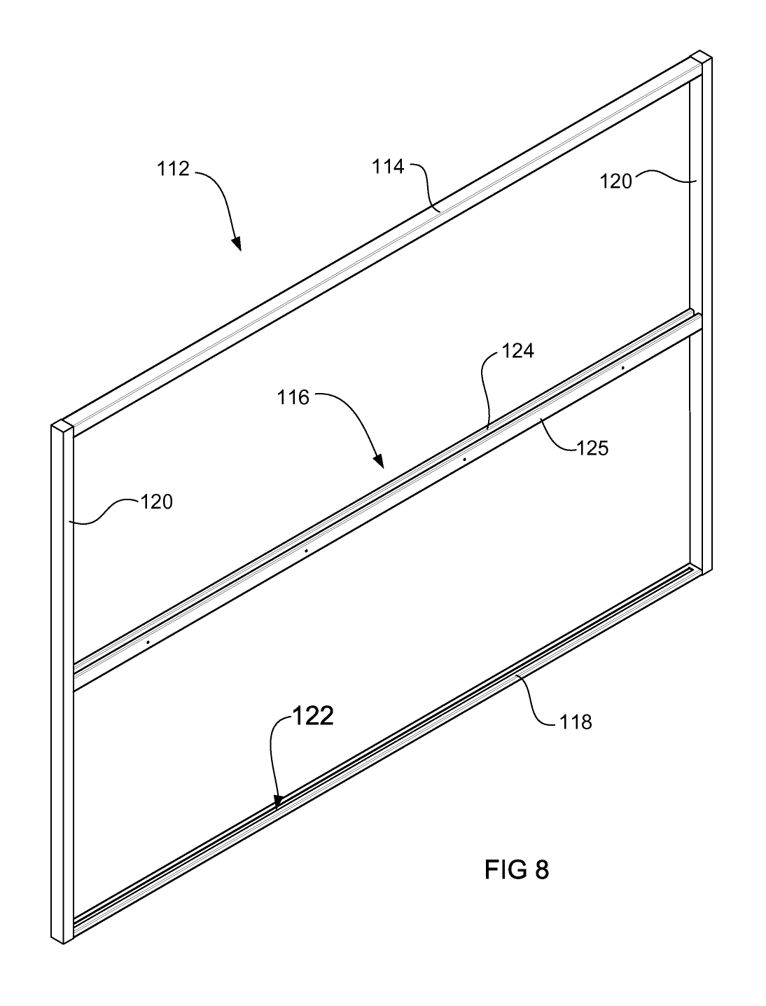

Referring firstly to FIGS. 7 and 8, the fencing panel 110 comprises a metal framework 12 which hold a plurality of paling members 123. Like the previous embodiment, the metal framework 112 has an elongate top rail 114, an elongate intermediate rail 16 and an elongate bottom rail 118 connected at their ends between two metallic side posts 120. Each of the top rail 114, intermediate rail 116 and bottom rail 118 are spaced apart substantially parallel to one another along the height of each side post 120 with the intermediate rail 16 located midway between the top rail 114 and bottom rail 118. As shown in FIG. 2, each of the top rail 114 and bottom rail 118 include an elongate channel type opening 122 configured to receive a plurality of end portions of a fence paling members 123 arranged with adjacent longitudinal ends of adjoining paling members 123 in substantially abutting contact. Each paling member 123 is rectangular in shape when viewed in plane and is elongate and solid.

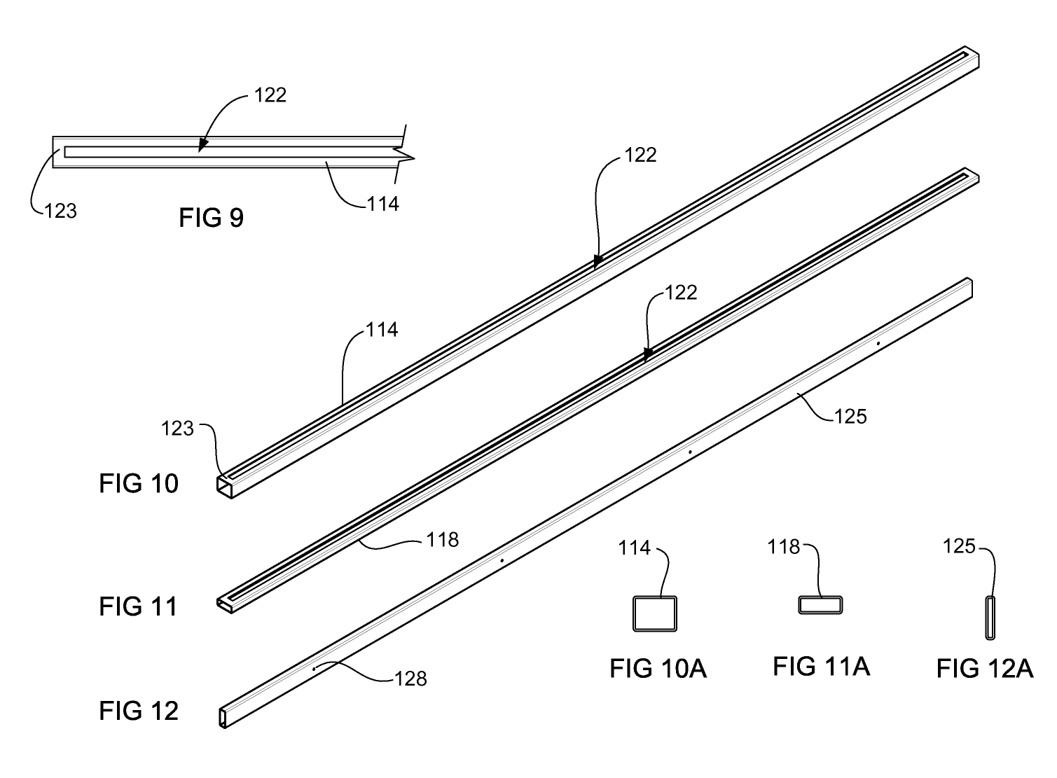

As best seen in FIGS. 9 to 12, each of the top rail 114, intermediate rail 116 and bottom rail 118 is formed from an elongate rectangular metal hollow section tubes, though it should be appreciated that other shapes such as a “C” shape, “V” shape or similar could also be used. Each of the top rail 114 and bottom rail 118 has a single elongate rectangular opening running along the length of the rail member 114, 118. The ends of each rail member 114, 118 include a small solid connection section 125 which spaces apart each side of the opening 122. Therefore, when the top portions and bottom portions of each paling member 123 can be inserted into the openings and then moved to abut each other in an end-to-end configuration. This configures the paling members 123 into a closed pattern (see FIG. 7).

As best shown in FIG. 8, the intermediate rail 16 is once again formed from two elongate metal members 124, 125. Each elongate member 124, 125 extend over a portion of the outwardly facing faces of the paling members 123 and compress proximate paling member 123 portions between each elongate member 124, 125. FIG. 12 shows one half 125 of the intermediate rail 116, showing it is formed from a rectangular metal hollow section tube and has four spaced apart fastening holes 128 drilled along its length. Fasteners (not shown), such as bolts, are fixed through each elongate member 124, 125 along the length of the assembly 110. The bolts pass through each fastening hole 128 in the front half of the rail 125 and through a corresponding hole (not shown) in the rear half of the rail 124 and can be fastened by a nut (not shown). Tightening the bolt moves the two halves of the intermediate rail 116 together, compressing the paling members and holding the paling members together between these halves 124, 125.

The intermediate rail 116 compresses the middle section of paling members 123 together to reduce lateral and perpendicular (relative to the longitudinal length of the paling members 123) movement of the paling members 123 between the top 114 and bottom rail 118. Only minimal gaps between paling members 123 from after the halves 124, 125 of the intermediate rail 116 are clamped around the paling members 16. The intermediate rail 116 is also useful in preventing warping of the palings, particularly soft wood palings, due to weathering, ageing, and variations in humidity or the like.

These assemblies 10, 110 can be readily assembled to fence posts which also delimit the end of the assembly and prevent the palings from falling out of the ends of the rail when the assemblies are assembled to the posts. In some embodiments, the fence posts 20, 120 have a channel configuration (not shown) adapted to accommodate the top 14, 114, bottom 18, 118 and intermediate rail 16, 116, within the channel. Pairs of such channels can be assembled back-to-back to provide for continuous fencing. In other embodiments, each of the ends of the top 14, 114, bottom 18, 118 and intermediate rail 16, 116 include a flange or shape projection (not shown) which can be fastened to the side posts 20, 120. In some arrangements, the side posts 20, 120 may have recessed adapted to receive the flanges. In other arrangements, the flanges may be fastened to the side posts using fasteners such as bolts or the like.

The illustrated fencing assemblies 10, 110 may be pre-assembled assemblies of fencing, or may be constructed on site into the fence between ground engaging vertical side posts.

A fence arrangement of the present invention can be easily constructed into a fencing panel 10, 110 on site. This is achieved by setting a plurality of side posts 20, 120 to the correct level in spaced apart locations along a border or other boundary along which the fence is to be constructed. The bottom rail 18, 118 is then fixed between the side posts 20, 120 at a lower level close to ground level and the top rail 14, 114 loosely attached to the side posts 20, 120 at a higher level, the top rail 14, 114 and bottom rail 18, 118 spaced apart approximately the length of the paling members 23, 123 desired to be used in the fence. Each paling member 23, 123 is then slotted into the respective opening in the bottom rail 18, 118 and fastened within the corresponding opening in the top rail 14, 114. Paling member 23, 123 are progressively slotted into the opening(s) 22, 122 until the paling members 23, 123 span the distance between the side posts 120. The two halves 24, 25, 124, 125 of the intermediate rail 16, 116 are then attached the respective sides of the paling members 23, 123 at an intermediate position between the top rail 14, 114 and the bottom rail 18, 118. Each fastener (in the illustrated embodiments shown in FIGS. 1 and 7, four fasteners are used) is fixed through the first half 25, 125 and second half 24, 124 of the intermediate rail 16, 116 and tightened to compress the paling members 23, 123 between each half of the intermediate rail 16, 116.

Those skilled in the art will appreciate that the invention described herein is susceptible to variations and modifications other than those specifically described. It is understood that the invention includes all such variations and modifications which fall within the spirit and scope of the present invention.

Where the terms “comprise”, “comprises”, “comprised” or “comprising” are used in this specification (including the claims) they are to be interpreted as specifying the presence of the stated features, integers, steps or components, but not precluding the presence of one or more other feature, integer, step, component or group thereof.

We claim:

1. A fencing assembly comprising:
a plurality of elongate paling members having a top and a bottom and longitudinal sides;
at least one top rail which includes at least one opening configured to receive a top portion of at least one paling member;
at least one bottom rail which includes at least one opening configured to receive a bottom portion of at least one paling member;
at least two side members extending between the top rail and bottom rail; and
at least one intermediate rail spaced between top rail and bottom rail, the intermediate rail comprising two elongate members, each elongate member extending over a portion of opposite longitudinal sides of paling members proximate the intermediate rail and compress these portions of the paling members between each elongate member.

2. A fencing assembly according to claim 1, wherein the top rail and bottom rail include a plurality of openings adapted to receive overlapping paling members, the openings arranged in two substantially parallel rows with adjoining openings from each row being staggered to provide a lapped array of openings.

3. A fencing assembly according to claim 2, wherein each row of openings being spaced apart from each adjoining opening in the same row and longitudinally overlapping a portion each adjacent opening in the other row.

4. A fencing assembly according to claim 2, wherein each opening is configured to receive a single top or bottom portion of a paling member.

5. A fencing assembly according to claim 2, wherein each opening is typically rectangular in shape.

6. A fencing assembly according to claim 1, wherein the top rail and bottom rail include at least one elongate opening adapted to receive two or more paling members arranged with adjacent longitudinal ends of adjoining paling members in substantially abutting contact.

7. A fencing assembly according to claim 6, wherein the opening in the top rail and bottom rail comprises a single elongate channel having a width which substantially accommodates the width of the paling member receivable within the opening.

8. A fencing assembly according to claim 1, wherein a first half of the intermediate rail is attached to a first side of the assembly and a second half of the intermediate rail is attached to the second side of the assembly, and at least one fastener is fixed through the first half and second half along the length of the intermediate rail to compress the palings between each half of the intermediate rail.

9. A fencing assembly according to claim 8, wherein a fastener is fixed through the first half and second half at three or more, preferably four or more points along the length of the intermediate rail.

10. A fencing assembly according to claim 9, wherein the fastener comprises a bolt and nut which extends through openings formed within each half of the intermediate rail and the respective palings.

11. A fencing assembly according to claim 1, wherein each of the top rail, bottom rail and intermediate rail comprise an elongate metal tube having a rectangular hollow section.

12. A fencing assembly according to claim 1, wherein each of the ends of the top rail, bottom rail and intermediate rail include a flange or shape projection which can be fastened to the side members.

13. A fencing assembly according to claim 1, wherein each side member include a channel section adapted to receive the end sections of the top rail, bottom rail and intermediate rail of the fence assembly.

14. A fencing assembly according to claim 1, wherein the side members comprise side posts which are fixable into the ground.

15. A fence panel formed from the fence assembly according to claim 1.

16. A method of assembling a fence including:
providing a fencing assembly according to claim 1;
positioning a plurality of fence posts into the ground in a spaced apart arrangement, the fence post including the side members;
attaching a plurality of top rail and bottom rails between adjoining fence posts;
supporting a plurality of paling members between each of the top rail and bottom rails, a top portion of each paling member being located in an opening of the top rail and a bottom portion of each paling member being located in an opening of the bottom rail; and
attaching at least one intermediate rail spaced between top rail and bottom rail, the intermediate rail comprising two elongate members, each elongate member extending over a portion of opposite longitudinal sides of paling members proximate the intermediate rail and compress these portions of the paling members between each elongate member.

17. A method of assembling a fence according to claim 16, wherein a first half of the intermediate rail is attached to a first side of the assembly and a second half of the intermediate rail is attached to the second side of the assembly, and at least one fastener is fixed through the first half and second half along the length of the intermediate rail to compress the palings between each half of the intermediate rail.

18. A method of assembling a fence according to claim 17, wherein a fastener is fixed through the first half and second half at three or more, preferably four or more points along the length of the intermediate rail.
